(19) United States
(12) Patent Application Publication
(10) Pub. No.: US 2015/0046329 A1
(43) Pub. Date: Feb. 12, 2015

(54) NEAR SOUND COMMUNICATION (NSC) PAYMENT SYSTEM

(71) Applicant: FUNDAMO (PTY) LTD, Cape Town (ZA)

(72) Inventors: Horatio Nelson Huxham, Cape Town (ZA); Cornelius Johannes Badenhorst, Cape Town (ZA); Alan Joseph O'Regan, Cape Town (ZA); Tara Anne Moss, Cape Town (ZA)

(21) Appl. No.: 14/375,124

(22) PCT Filed: Jul. 22, 2013
(86) PCT No.: PCT/IB2013/050546

§ 371 Date: Jul. 28, 2014

Related U.S. Application Data
(60) Provisional application No. 61/593,085, filed on Jan. 31, 2012.

(51) Int. Cl. G06Q 20/32; G06Q 20/40; G06F 3/16

(52) U.S. Cl. CPC G06Q 20/3272; G06F 3/16; G06Q 20/4014
USPC 705/44

(57) ABSTRACT

Systems, methods, apparatuses, and computer-readable media for using near sound communication (NSC) functionalities to complete transactions are presented. According to one or more aspects, a payment server may receive a data message from a payor's telephone, and the data message may include a user-specified password. In response to validating the payor based on the user-specified password, a call may be initiated to the payor's telephone. Subsequently, a unique audio stream may be played over the call. The unique audio stream may be adapted to be captured by a merchant point-of-sale terminal for use in completing a transaction. In some arrangements, the unique audio stream may include encoded information identifying the payor and/or identifying an amount of funds to be paid.

### CROSS-REFERENCES TO RELATED APPLICATIONS

This application claims priority to U.S. provisional patent application No. 61/593,085 filed on 31 Jan. 2012.

### BACKGROUND OF THE INVENTION

Aspects of the disclosure relate to computing technologies and/or payment technologies. In particular, one or more aspects of the disclosure relate to a payment system that uses near sound communication (NSC) functionalities to complete transactions.

Typically, in completing a transaction, such as purchasing goods and/or services at a grocery store or other merchant location, a customer or “payor” has to exchange payment information with the merchant or “payee.” Current systems may enable this exchanging of payment information by providing the payor with a magnetic payment card or other portable payment device and by providing the payee with a magnetic payment card reader or some other terminal capable of receiving information from such portable payment devices. This arrangement, however, not only requires merchants to possess specialized equipment in the form of card readers and/or other specialized terminals, but also requires the magnetic payment cards or other portable payment devices to be physically distributed to the payors. Aspects of the disclosure provide more convenient ways of completing transactions by addressing these and other problems.

### BRIEF SUMMARY OF THE INVENTION

Aspects of the disclosure generally discuss technologies for using near sound communication (NSC) functionalities to complete transactions. As described in greater detail below, aspects of the disclosure have a number of advantages over the prior art, including improved transaction security, enhanced reliability, greater interoperability between systems, and easier upgradability. More specifically, because the technologies described herein rely on devices that payors and payees may already possess, such as cellular telephones, landline telephones, and/or other mobile devices, aspects of the disclosure may be implemented without burdensomely requiring such payors and payees to obtain specialized equipment. Further still, because the technologies described herein make use of devices that payors and payees may already posses, aspects of the disclosure may be implemented and the functionalities described herein may be provided to payors without physically distributing portable payment devices to such payors. In addition, because the techniques described herein call for one or more payment server computers performing much, if not all, of the more complex processing operations, aspects of the disclosure may be implemented and provided to payors who have only simple user devices, such as basic cellular phones that may be capable of data messaging (e.g., SMS and/or USSD messaging), but might otherwise lack “smartphone” capabilities, such as the ability to download and execute third-party applications, which are sometimes referred to as “apps.” In other words, techniques described herein may be “phone agnostic” in that these techniques may be implemented in arrangements involving smartphones and non-smartphones alike.

According to one or more aspects of the disclosure, a payment server may receive a data message from a payor's telephone, and the data message may include a user-specified password. In response to validating the payor based on the user-specified password, a call may be initiated to the payor's telephone. Subsequently, a unique audio stream may be played over the call. The unique audio stream may be adapted to be captured by a merchant point-of-sale terminal for use in completing a transaction.

In at least one arrangement, prior to receiving the data message, the payment server may provide a menu to the payor's telephone, and in response to receiving a user selection of at least one option included in the menu, the payment server may prompt the payor to enter the user-specified password. In at least one additional and/or alternative arrangement, the menu may be a USSD menu, and the user-specified password may be received via a USSD gateway.

In one or more arrangements, the unique audio stream may include encoded information identifying the payor and/or identifying an amount of funds to be paid.

### BRIEF DESCRIPTION OF THE DRAWINGS

FIG. 1 illustrates an example operating environment in which one or more illustrative aspects of the disclosure may be implemented.

FIG. 2 illustrates an example method of using NSC functionalities to complete a transaction according to one or more illustrative aspects of the disclosure.

FIG. 3 illustrates an example method of using NSC functionalities to complete a transaction at a merchant device according to one or more illustrative aspects of the disclosure.

FIG. 4 illustrates a second example method of using NSC functionalities to complete a transaction at a merchant device according to one or more illustrative aspects of the disclosure.

FIGS. 5 and 6 illustrate another example method of using NSC functionalities to complete a transaction according to one or more illustrative aspects of the disclosure.

FIG. 7 illustrates an example of a computer apparatus in which various aspects of the disclosure may be implemented.

### DETAILED DESCRIPTION OF THE INVENTION

In this description, the term “encoded” is intended to mean any method of representing digital data in a sound wave and might include modifying one or more properties of that sound wave. Embodiments of the invention provide for the encoding of information onto an audio stream to include modulating a digital representation of the information onto a sound wave and for the methods of modulation to include, for example, amplitude modulation (AM), frequency modulation (FM), phase modulation (PM), quadrature amplitude modulation (QAM), frequency shift keying (FSK), phase shift keying (PSK), trellis code modulation (TCM), or the like.

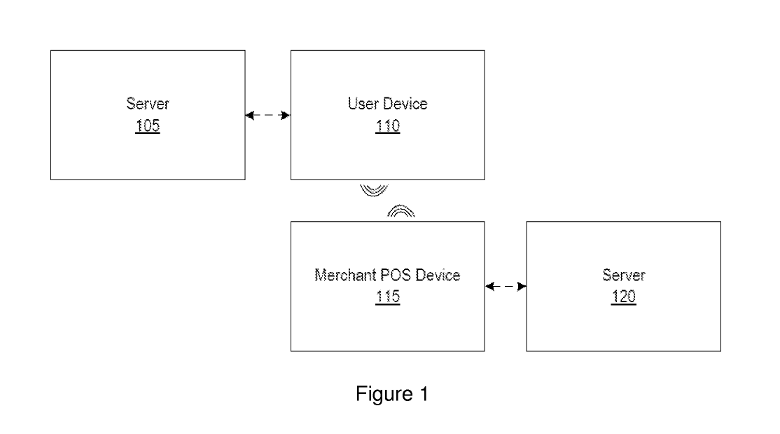

FIG. 1 illustrates an example operating environment in which one or more illustrative aspects of the disclosure may be implemented. As seen in FIG. 1, a server computer, such as payment server 105, may electronically communicate with one or more user devices, such as user device 110. In one or more arrangements, payment server 105 may be a back-office computer system that is operated by a financial institution, a mobile money service provider and/or a payment processing network. Additionally or alternatively, payment server 105 may be configured to store account information about one or more accountholders (who may, for instance, be customers of the financial institution, the mobile money service provider and/or the payment processing network). Payment server 105 may further be configured to process transaction authorization request messages received from one or more merchants.

According to one or more aspects, payment server 105 may communicate with the one or more user devices (e.g., user device 110) via one or more cellular communication channels, Public Switched Telephone Network (PSTN) channels, and/or any other wired and/or wireless communication channels.

In one or more arrangements, user device 110 may be a cellular telephone that may include telephonic and data messaging capabilities. In some instances, user device 110 may be a smartphone or other mobile computing device that may include functionalities enabling user device 110 to download and/or execute software applications, such as third-party applications or “apps.” In other instances, user device 110 may be a basic cellular phone that does not include such smartphone functionalities.

As shown in FIG. 1, there may be instances in which user device 110 exchanges audio information with a merchant point-of-sale (POS) terminal, such as merchant POS device 115, that is located near or otherwise in proximity to the user device 110. As described below, this audio information may include payment information encoded in the form of a unique audio stream that allows a user of user device 110 to complete a transaction with a merchant operating the merchant POS device 115. For example, user device 110 may include a speaker via which the unique audio stream (and/or any other audio information) may be emitted, and merchant POS device 115 may include a microphone that is adapted to capture the unique audio stream (and/or any other audio information) emitted by one or more user devices. Additionally or alternatively, user device 110 may include a microphone and merchant POS device 115 may include a speaker, such that merchant POS device 115 could similarly emit audio information and user device 110 could similarly capture such information.

According to one or more aspects, merchant POS device 115 may electronically communicate with one or more servers, such as server 120, which like server 105, may be a back-office computer system that is operated by a financial institution, a mobile money service provider and/or a payment processing network. For instance, server 120 may be operated by an acquiring bank, which may acquire credit and/or debit transactions from the merchant operating merchant POS device 115 (and other merchants) for processing via the payment processing network. In some arrangements, merchant POS device 115 may be a conventional payment card-reader device that includes and/or has been equipped with a microphone and/or speaker, e.g., for use in completing NSC transactions. In other arrangements, merchant POS device 115 may be a landline telephone, a basic cellular telephone, a smartphone, or another type of computing device that can be used by the merchant.

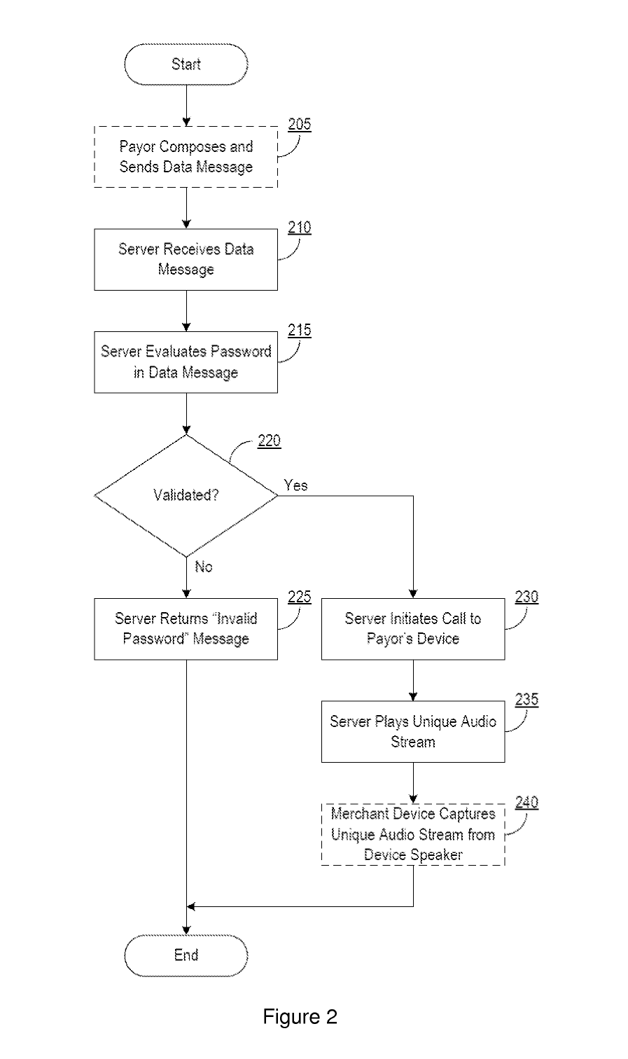

Having described an example environment in which one or more aspects of the disclosure may be implemented, an example method that may be practiced within this environment will now be described with respect to FIG. 2.

FIG. 2 illustrates an example method of using NSC functionalities to complete a transaction according to one or more illustrative aspects of the disclosure. In step 205, a payor may compose and send a data message, e.g., using a mobile device or cellular telephone, such as user device 110. In some arrangements, the data message may be a text message, such as a Short Messaging Service (SMS) text message or a Multimedia Messaging Service (MMS) message, that includes a personal identification number (PIN) or other password, which may be specified by the user and associated with a financial account owned by the user. In other arrangements, the data message may be an Unstructured Supplementary Service Data (USSD) message that includes such a user-specified PIN or other password, and the user may compose the message manually or the message may be generated automatically by the user device 110, e.g., based on user input received in response to one or more prompts and/or other menus.

After the message is sent in step 205, a server computer, such as payment server 105, may receive the data message, e.g., via one or more wired and/or wireless communication channels in step 210. Subsequently, in step 215, the server computer may evaluate the PIN or password included in the message in order to authenticate the user. For example, based on source information associated with the message (e.g., the telephone number of the device from which the message was sent), the server computer may identify the user who sent the message and subsequently may compare the PIN or password included in the message with information stored in records on the server computer to determine if the PIN or password included in the message matches a PIN or password stored in the records about the identified user. If the PIN or password included in the message matches the PIN or password stored in the records for the identified user, then the data message may be considered to be validated; otherwise, the data message may be considered to be not validated.

In step 220, the server computer may determine whether the data message was validated, e.g., in step 215. If it is determined, in step 220, that the data message was not validated, then in step 225, the server computer may return a message to the payor's user device indicating that the PIN or password included in the data message is invalid.

On the other hand, if it is determined, in step 220, that the data message was validated, then in step 230, the server computer may initiate a call to the payor's user device. For example, in step 230, the server computer (e.g., payment server 105) may place a telephone call to the payor's user device (e.g., user device 110) via one or more cellular communication channels and/or one or more PSTN channels. It will be appreciated that in many countries, receiving a telephone call is free to the recipient, so the payor is not required to incur any telephone call charges associated with receiving the telephone call from the server computer.

Subsequently, in step 235, the server computer may play a unique audio stream over the telephone call with the payor's user device. The payor's user device then may play the unique audio stream through a speaker included in the user device, such that the unique audio stream can be captured by a merchant device (e.g., merchant POS device 115) positioned near the user device. In one or more arrangements, the unique audio stream may serve as the payor's credentials to complete the transaction and/or may include encoded information identifying the payor and/or the amount of funds to be paid. The encoded information identifying the payor may include, for instance, the payor's name, one or more account numbers associated with the payor's financial account(s), and/or other information.

Thereafter, the merchant device (e.g., merchant POS device 115) may capture the unique audio stream and subsequently may communicate with one or more server computers (e.g., server 120) to process, authorize, and/or otherwise complete the transaction. The steps involved in capturing the unique audio stream at POS device 115 and communication therefrom to a payment server can take on various embodiments.

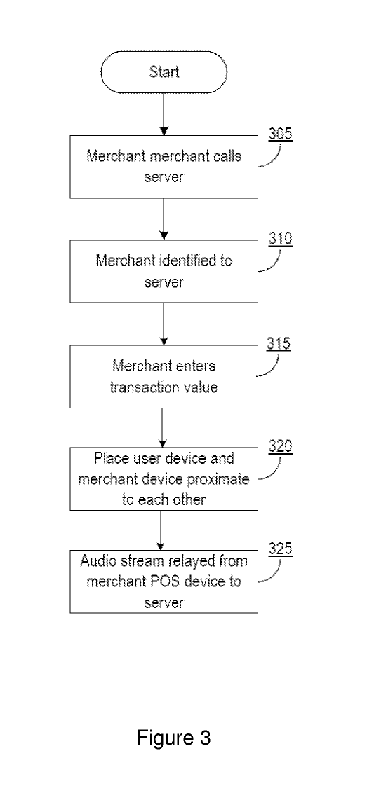

For example and with reference to FIG. 3, merchant POS device might be a landline telephone. In this embodiment a merchant makes a call to server 120 using merchant POS device 115 in step 305, for example by dialing a telephone number. Server 120, being configured to interact with the merchant via interactive voice response (IVR) might then prompt the merchant to enter a merchant identifier via an IVR prompt in step 310. The merchant then enters the merchant identifier into a keypad of merchant POS device 115. The entering of information by the merchant into the keypad of merchant POS device 115 is interpreted by server 120 by dual tone multi-frequency (DTMF) tones. Server 120 is then operable to interpret the DTMF tones so as to obtain the information entered by the merchant. Alternatively, server 120 might obtain a telephone number of merchant POS device 115 so as to identify the merchant. In any event, having identified the merchant, server 120 might prompt user the merchant, via an IVR prompt, to enter a transaction value in step 315. The merchant then enters a transaction value for the relevant purchase into the keypad of merchant POS device 115. The transaction value entered is communicated to the server via DTMF tones. Responsive to receiving a transaction value, server 120 might prompt the merchant to position merchant POS device 115 in close proximity to user device 110 so as to complete the transaction in step 320. When merchant POS device 115 and user device 110 are placed are proximate each other, a microphone of merchant POS device 115 is operable to sample an audio stream being emitted from a loudspeaker of user device 110, the audio stream being emitted from user device 110 having been requested according to previously described methods the invention. The audio stream received at merchant POS device 115 is then relayed to server 120 over the phone call in step 325. Thereafter, the audio stream is captured, decoded and/or decrypted by server 120 and/or other server computers so as to process, authorize, and/or otherwise complete the transaction.

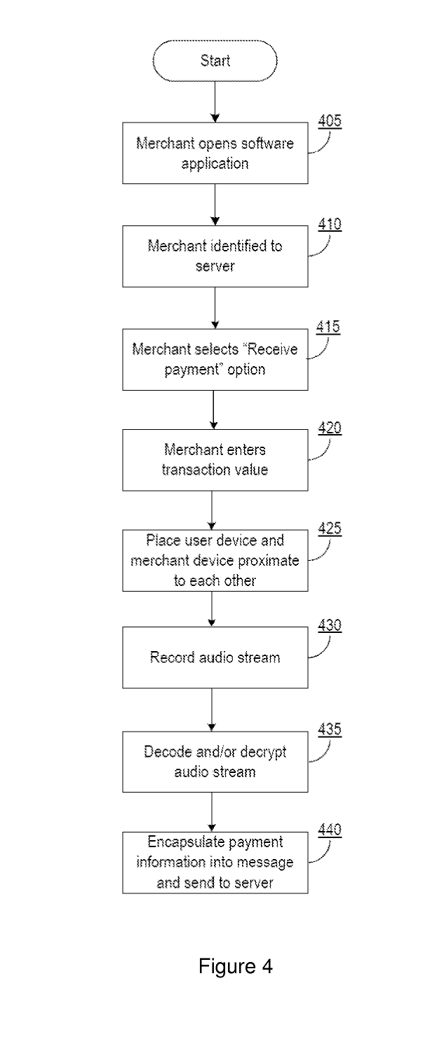

In another embodiment, merchant POS device 115 might be a smartphone. In this embodiment, merchant POS device 115 might have a software application resident thereon. The software application might facilitate the receiving of an audio stream through a microphone of merchant POS device 115. The software application might further facilitate recording and storing of the audio stream and might also provide functionality for decoding the received audio stream into payment information for communicating to, for example, server 120 so as to complete the transaction. An example of this embodiment is further described with reference to FIG. 4. The embodiment provides for operations done on merchant POS device 115 to be done through the software application.

In step 405, a merchant opens the application resident on merchant POS device 115. The merchant might be requested to provide a merchant identifier in step 410 for communication to server 120, or merchant POS device 115 might automatically provide a merchant identifier. The merchant identifier might be any one of a telephone number of merchant POS device 115, a merchant specified identifier or a hardware identifier of merchant POS device 115.

In step 415, the merchant selects a “receive payment” option on merchant POS device 115 and in step 420 enters a transaction value into merchant POS device 115. Merchant POS device 115 then prompts the merchant to place merchant POS device 115 and user device 105 in close proximity to each other in step 425. When merchant POS device 115 and user device 110 are placed are proximate each other in step 430, merchant POS device 115 enables a microphone of merchant POS device 115 and records an audio stream being emitted from a loudspeaker of user device 110, the audio stream being emitted from user device 110 having been requested according to previously described methods the invention.

Having recorded the audio stream, merchant POS device 115 then decodes and/or decrypts the audio stream in step 435 so as to extract the relevant payment information. The payment information is then encapsulated in a message and sent to server 120 in step 440 so that the transaction can be processed, authorized, and/or otherwise completed. Alternatively, merchant POS device 115 might not decode and/or decrypt the audio stream but might rather communicate the audio stream to server 120 where it might be received, decoded and/or decrypted by server 120 and/or other server computers so as to process, authorize, and/or otherwise complete the transaction.

The above embodiment provides scope for a variety of modifications. For example, it is anticipated that instead of the merchant identifying him- or herself in step 410, a merchant identifier might rather be included in the message to be sent to server 120 in step 440. It should also be appreciated that embodiments of the invention also provide for merchant POS device 115 to not be a smartphone, but rather a feature phone, or indeed any type of cellular phone. Such embodiments might rely on merchant POS device 115 recording an audio stream being emitted from a loudspeaker of user device 110. The recorded audio stream might then be communicated to server 120 in, for example a multimedia messaging service (MMS) message, electronic mail, social media message or any other multimedia messaging medium or protocol. Thereafter, the audio stream is captured, decoded and/or decrypted by server 120 and/or other server computers so as to process, authorize, and/or otherwise complete the transaction.

Embodiments of the invention further provide for methods to overcome possible fluctuations in signal quality between, for example, payment server 105 and user device 110, user device 110 and merchant POS device 115, or merchant POS device 115 and server 120. Such methods might, for example, include payment server 105 playing the unique audio stream according to aspects of the invention a predetermined number or times. The unique audio stream might include information indicating the start of the audio stream and similarly information indicating the end of the audio stream so as to enable a system or computer decoding the audio stream to correctly extract the information included in the audio stream. Alternatively, payment server 105 might repeat the audio stream until receiving, for example, a message indicating that the transaction was successful. Upon receiving such a message, payment server 105 might terminate the phone call to user device 110.

Embodiments of the invention provide for the information contained in the audio stream to be information required to complete a financial transaction. In one embodiment, for example, the information might include a primary account number (PAN), Card Verification Value (CVV) number, an account holder name, etc. belonging to a user requesting an audio stream in order to complete a transaction. Once decoded, this information can then be communicated to relevant servers and/or computers so as to complete a transaction. This communication might be over existing payment communication networks and might include additional service providers to facilitate the completing of the transaction. The information included in the audio stream might further include a dynamic reference number. This dynamic reference number might, for instance, be included in a reference number field when completing the transaction and might serve so as to ensure that the audio stream can be used only a single time. Embodiments further provide for this dynamic reference number to populate an existing reference number field in existing financial transaction card originated messages (e.g. ISO 8583) as well as PAN, CVV, account holder's name etc. being placed in their respective fields. Having a dynamic reference number will ensure that an eavesdropper recording an audio stream being emitted by a user's device (e.g. user device 110) in the completing of a payment cannot use the same audio stream for payment a second time. In embodiments where the information contained in the audio stream includes personal information, such as a PAN which is not one time generated but which is static, the server may encrypt this information prior to encoding it, the information being decrypted by an acquiring bank to complete the financial transaction. Encryption may by means of techniques such as Data Encryption Standard (DES), Triple DES, Secure Socket Layer (SSL), Advanced Encryption Standard (AES), Blowfish, or other encryption standards.

In another embodiment, however, a single-use PAN might be included in the audio stream, in which case encryption may not be necessary. In this embodiment, the single-use PAN might be valid for a single use only. For example, responsive to receiving a request for an audio stream from user device 110, payment server 105 might generate a single-use PAN corresponding to a user account of a user of user device 110. Payment server 105 might then encode this single-use pan onto an audio stream which is then played over a telephone call placed to user device 110 by payment server 105. The single-use PAN might still be provided together with static routing information (such as a static Bank Identification Number or BIN) such that a decoded audio stream information at server 120 might be used by server 120 and/or other server computers to process, authorize, and/or otherwise complete the transaction.

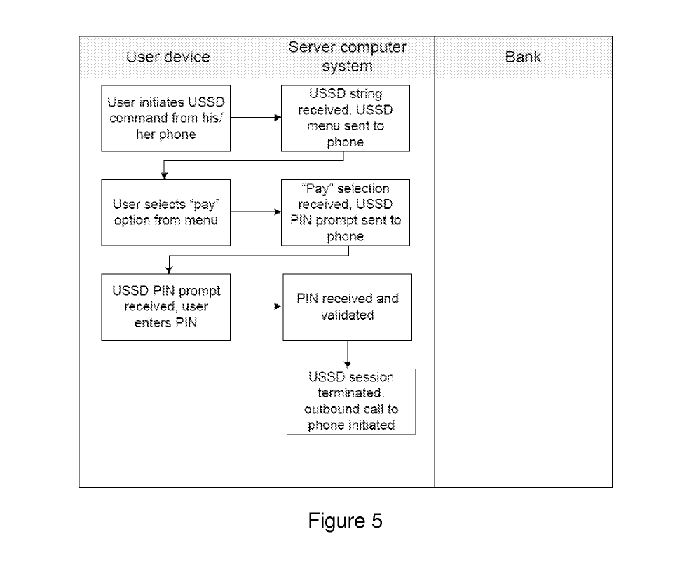

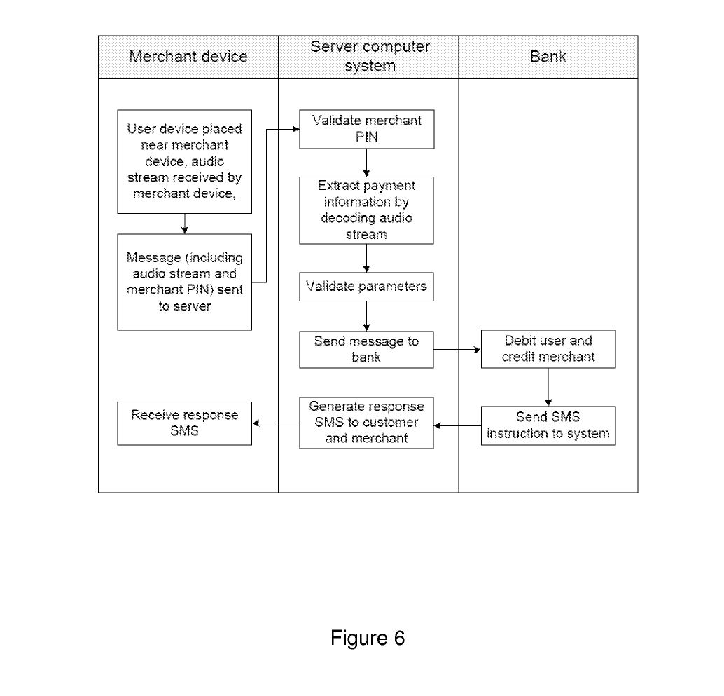

Another example method of using NSC functionalities to complete a transaction will now be described with respect to FIGS. 5 and 6. As seen in FIGS. 3 and 4, one problem, among others, addressed by the illustrated example method is the problem of securely transferring account information, such as an account number, from one machine to the next, when one or both of the machines might not be smartphones. By having at least one of the non-smartphones initiate a message over any protocol to a back-end server, the back-end server can generate a digital sound over a call or in an MMS message that can be used to transfer the account information and complete the transaction.

For example, with reference to FIG. 5, a user wishing to complete a transaction, who might not have a smartphone, may initiate a USSD request by typing in a short code and pressing “dial” on their device (e.g. user device 110). Once the USSD string is received by the server computer system (e.g. payment server 105), the server computer system, which may include a USSD gateway, may provide the user's device with a USSD menu and/or otherwise cause such a USSD menu to be initiated and/or displayed to the user. The user may then select a “pay” option, and this selection may be sent back to the server computer system.

At this point, the server computer system may prompt the user for his or her PIN. When the user's PIN is validated by the server computer system, the server computer system may terminate the USSD session and initiate an outbound phone call to the user. The server computer system then may create an encrypted single-use PAN and encode this onto an audio stream which is then sent to the user's device over the phone call.

Referring now to FIG. 6, once the call is accepted by the user, he or she may hold their device (e.g., user device 110 which might be their phone handset) close to the merchant's device (e.g., merchant POS device 115 which might be the merchant's cellular phone, the merchant's smartphone, etc.). The merchant's device may then capture and/or otherwise receive the sound signal and complete a transaction by preparing a transaction message to be sent to the server computer system (which might be server 105 or server 120 in communication with server 105). The message might contain a PIN of the merchant and/or a merchant identifier in addition to the captured audio stream. The merchant's device might not be “online” at this point; rather, it may gather this information and send it all to the server computer system at the end (e.g., at the end of capturing the sound).

Thereafter, the transaction message may be sent securely to the server computer system, which may validate all parameters of the transaction message, and, if such parameters are correct, may send a debit and/or credit message to a bank. The bank in this case might be an acquirer of the merchant. The bank may then debit a bank account associated with the user the user and credit a financial account associated with the merchant (e.g., for the amount of the transaction). The details of the user's financial account are obtained by the bank from the decoded audio stream, while the details of the merchant's financial account might be obtained from a database entry stored in association with the merchant identifier and/or PIN. When this is successful, the bank may request for the server computer system to send an SMS message or other message that includes the outcome of the transaction to the merchant and/or the user. In some alternative arrangements, the server computer system may be configured to send such a message when a transaction is completed even in instances where such a request is not received from the bank.

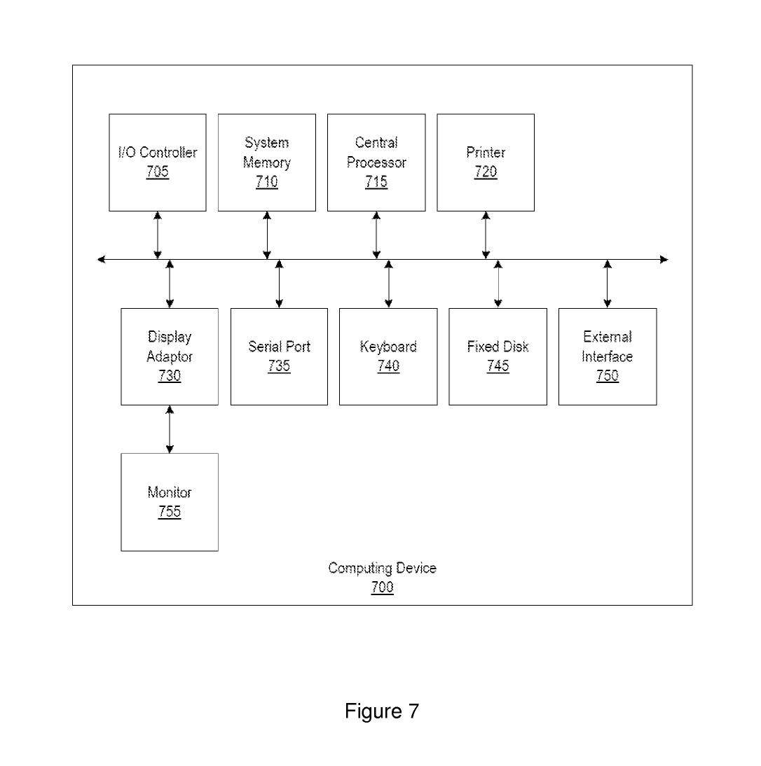

Having described several example methods of using NSC functionalities to complete a transaction, an example computing device that may be embody various aspects of the disclosure will now be described with respect to FIG. 7.

FIG. 7 illustrates an example of a computer apparatus in which various aspects of the disclosure may be implemented. The various participants and elements in the previously described system diagrams may use any suitable number of subsystems in the computing device to facilitate the functions described herein. Examples of such subsystems or components are shown in FIG. 7. The subsystems shown in FIG. 7 are interconnected via a system bus 725. Additional subsystems such as a printer 720, keyboard 740, fixed disk 745 (or other memory comprising computer-readable media), monitor 755, which is coupled to display adapter 730, and others are shown. Peripherals and input/output (I/O) devices (not shown), which couple to I/O controller 705, can be connected to the computer system by any number of means known in the art, such as serial port 735. For example, serial port 735 or external interface 750 can be used to connect the computer apparatus to a wide area network such as the Internet, a mouse input device, or a scanner The interconnection via system bus 725 allows the central processor 715 to communicate with each subsystem and to control the execution of instructions from system memory 710 or the fixed disk 745, as well as the exchange of information between subsystems. The system memory 710 and/or the fixed disk 745 may embody a computer-readable medium.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Aspects of the disclosure can be implemented in the form of control logic in software or hardware or a combination of both. The control logic may be stored in an information storage medium as a plurality of instructions adapted to direct an information processing device to perform a set of steps disclosed herein. Based on the disclosure and teachings provided herein, a person of ordinary skill in the art will appreciate other ways and/or methods to implement the present invention.

In some embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. For example, the invention is not limited to financial payment transactions but could be used for transactions such as redeeming coupons, obtaining ringtones, transferring contact details, and many others. Many variations of aspects of the disclosure will become apparent to those skilled in the art upon review of the disclosure. The scope of the disclosure should, therefore, be determined not with reference to the above description, but instead should be determined with reference to the appended claims along with their full scope or equivalents.

1. A method comprising:
receiving, at a payment server, a data message from a payor's telephone, the data message including a user-specified password;
in response to validating the payor based on the user-specified password, initiating a call to the payor's telephone; and
playing a unique audio stream over the call,
wherein the unique audio stream is adapted to be captured by a merchant point-of-sale terminal for use in completing a transaction.

2. The method of claim 1, further comprising:
prior to receiving the data message:
providing, by the payment server, a menu to the payor's telephone; and
in response to receiving a user selection of at least one option included in the menu, prompting, by the payment server, the payor to enter the user-specified password.

3. The method of claim 2,
wherein the menu is an Unstructured Supplementary Service Data (USSD) menu, and
wherein the user-specified password is received via a USSD gateway.

4. The method of claim 1, wherein the unique audio stream includes encoded information identifying the payor.

5. The method of claim 1, wherein the unique audio stream includes encoded information identifying an amount of funds to be paid.

6. The method of claim 1, wherein the unique audio stream includes single-use information so as to prevent the audio stream from being used for more than one transaction.

7. The method of claim 6, wherein the single-use information includes a single-use primary account number (PAN) generated by the payment server.

8. The method of claim 6, wherein the single-use information includes a dynamic reference number.

9-14. (canceled)

15. The method of claim 1, wherein validating the payor is based on the user-specified password and a user identifier, and wherein the user identifier is obtained from a telephone number of the telephone.

16. A system comprising:
a payment server including:
a data communication channel configured to receive a data message containing a user-specified password from a telephone of a payor;
a processor configured to validate the payor based at least partially on the user-specified password by comparing the user-specified password with information stored in memory of the payment server;
the processor configured to initiate a telephone call via an audio communication channel to the payor's telephone and to play a unique audio stream over the call.

17. The system of claim 16, including:
a telephone belonging to a payor and configured to send a data message to the payment server, to receive a telephone call from the payment server and to emit audio content of the telephone call through a loudspeaker.

18. The system of claim 16, including:
a merchant point-of-sale terminal, in which the terminal includes a microphone and is configured to record the audio content emitted from the loudspeaker of the payor's telephone when the payor's telephone is held in close proximity to the merchant point-of-sale terminal, to optionally decode the audio stream, and to transmit either the original audio stream or the decoded audio stream to a server computer for use in completing a transaction.

19. The system of claim 16, wherein the unique audio stream contains information required for completing the transaction.

20. The system of claim 16, wherein the telephone is a cellular phone.

21. The system of claim 18, wherein the merchant point-of-sale terminal is a cellular phone, wherein the cellular phone is configured to record an audio stream input into a microphone of the cellular phone, and wherein the cellular phone is configured to send the recorded audio stream to the server computer so that a payment transaction can be processed.

22. The system of claim 18, wherein the merchant point-of-sale terminal is a computer with a microphone, wherein the computer is configured to record an audio stream input to the microphone, wherein the computer is configured to send the recorded audio stream to the server computer so that a payment transaction can be processed.

23. The system of claim 16, wherein the payment server is configured to validate the payor based on the user-specified password and a user identifier, and wherein the user identifier is obtained from a telephone number of the telephone.

24. A computer program product comprising a non-transient computer readable storage medium having computer-readable program code embodied therewith, the computer-readable program code configured to:
receive a data message from a payor's telephone, the data message including a user-specified password;
validate the payor based on the user-specified password;
initiate a call to the payor's telephone; and
play a unique audio stream over the call,
wherein the unique audio stream is adapted to be captured by a merchant point-of-sale terminal for use in completing a transaction.

25. The computer program product of claim 19, wherein the code is configured to:
prior to receiving the data message, provide a menu as an Unstructured Supplementary Service Data (USSD) menu to the payor's telephone; and
in response to receiving a user selection of at least one option included in the menu, prompt the payor to enter the user-specified password,
and wherein the user-specified password is received via a USSD gateway.
